(19) United States
(12) Patent Application Publication
(10) Pub. No.: US 2004/0078494 A1
(43) Pub. Date: Apr. 22, 2004

(54) System and apparatus for implementing devices interfacing higher speed networks using lower speed network components

(76) Inventors: Edward Alex Lennox, Saratoga, CA (US); Poly Palamuttam, San Jose, CA (US); Satish Sathe, San Ramon, CA (US)

Correspondence Address: Pillsbury Winthrop LLP, 1600 Tysons Blvd., McLean, VA, 22102, US

(21) Appl. No.: 10/256,057

(22) Filed: Sep. 25, 2002

(51) Int. Cl. G06F 3/00

(52) U.S. Cl. 710/1

(57) ABSTRACT

Methods and systems for deploying higher-bandwidth networks using lower-bandwidth capable network processing devices. This provides for Parallel Network processing units (PNPU) to work together to process higher bandwidths in networking systems. The methods involve the utilization of several low speed busses to achieve a higher throughput; a CRC generation technique; and improving the performance of such busses using synchronization techniques.

### FIELD OF THE INVENTION

The present invention relates to communications systems. More particularly, the present invention is directed to high-speed, high-bandwidth transportation of data in such communications systems.

### BACKGROUND

The availability of more and more bandwidth in communication pipes introduces a number of implementation problems. Though higher and higher speed physical transport mechanisms are arriving in the marketplace, network equipment design often does not change fast enough to keep pace. FIG. 1 illustrates a typical line card utilized in a optical communications system such as OC-192 (system interface for physical and link layer devices) which accepts/generates 10 Gigabit/second traffic. The line card 100 includes a NPU (Network Processor Unit) 110 which performs Layer 3 (Network Layer) and Layer 4 (Transport Layer) processing on packets. These packets are encapsulated, framed and mapped using a Layer 2 (Data Link layer) and Layer 1 (Physical layer) processing unit 120 which is sometimes referred to as a framer. Other components of the line card 100 not shown include other physical layer devices and components such as optical transceivers. One specific challenge in this regard is the lack of availability of Network Processor Units such as NPU A10 which can handle 40 Gigabit/second traffic associated with communications systems based on OC-768, for example. This limitation prevents deployment of networks that can fully utilize new environments such as OC-768.

Interfaces between Layer 2 and Layer 3 components also have limitations. For instance, one widely adopted standard for OC-192 based networks (10 Gb/s) is OIF-SPI4-02.0 System Packet Level 4 (SPI-4) Phase 2. (hereinafter referred to as “SPI-4 Phase 2”). SPI-4 Phase 2 compliant buses are 16-bits wide and carry data at data rates frequencies typically between 600 and 800 Mbps over each bit of the bus. The net effect of this arrangement is capable of supporting a 10 Gigabit per second data rate. While this is an extremely popular bus and utilizes low power LVDS (Low Voltage Differential Signaling) circuitry it is incapable of supporting an OC-768 based network.

While there are bus standards such as SPI-5 (16-bit bus with each bit operating at 2.5 Gbits/s), these are difficult to implement in silicon because of the higher requisite speed of the I/O devices and matching problems.

Another issue in deploying higher and higher bandwidth networks is the use of legacy devices and interfaces such as framers and optical interfaces. While newer standards, such as SPI-5, are being put in place, system designers may not have access to the newer technology required to implement these standards. Access to newer technology may also be constrained by time (requires a long time to develop) and financial (requires large R&D investments to develop) constraints. Therefore, often, rather than replacing these legacy devices, system designers will prefer to use them instead. Further, since new devices supporting the higher bandwidth networks may not be available there is a need to enable the use of legacy devices in deployment.

Thus, there is a need for new techniques and apparatus enabling more rapid and immediate deployment of such networks even in the absence of equipment specifically tailored to handle them.

### SUMMARY OF THE INVENTION

The invention consists in various embodiments of methods and systems for deploying higher-bandwidth networks using lower-bandwidth capable network processing devices. It enables Network processors to work as Parallel-Network-Processing Units (PNPU) to process higher bandwidths than would be possible by any of them individually. The methods involve the utilization of several low speed busses to achieve a higher throughput; a CRC generation technique; and improving the performance of such busses using synchronization techniques.

### BRIEF DESCRIPTION OF THE DRAWINGS

FIG. 1 illustrates a typical line card utilized in a optical communications system such as OC-192 which accepts/generates 10 Gigabit/second traffic.

FIG. 2 shows a set of network processors operating in a parallel configuration as Parallel Network Processors enabled by use of one or more embodiments of the invention.

FIG. 3 illustrates a 40 Gb/s capable system implemented in accordance with one or more embodiments of the invention.

FIG. 4 illustrates at least a first operational mode of the DLL processing apparatus.

FIG. 5 illustrates at least a second operational mode of the DLL processing apparatus.

FIG. 6 illustrates at least a third operational mode of the DLL processing apparatus.

FIG. 7 shows a detailed functional block diagram of a DLP processing apparatus 320 according to at least one embodiment of the invention.

FIG. 15 illustrates one embodiment featuring a pipelined CRC architecture.

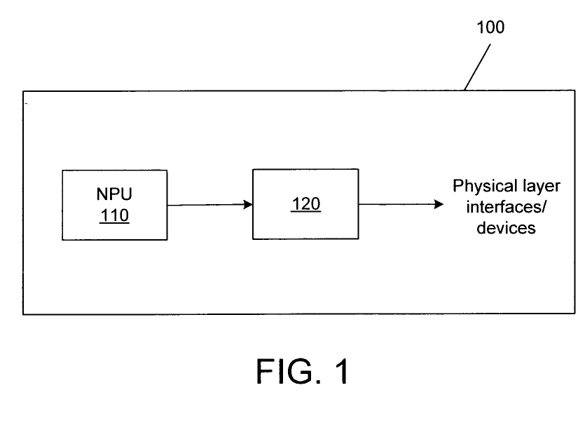

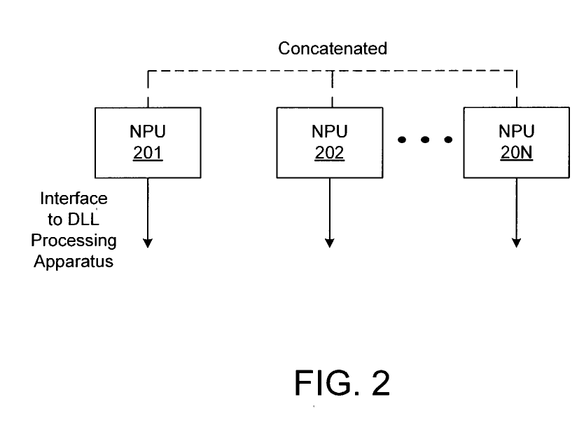

### DETAILED DESCRIPTION OF THE INVENTION

One solution to enable a higher speed network to be deployed involves utilizing a series of lower bandwidth network processors as Parallel Network processors so that they can cumulatively provide a higher bandwidth of traffic. FIG. 2 shows one such configuration where N NPUs (Network Processing Units) 201, 202, . . . 20N operate together in a parallel fashion such that they collectively handle N times the bandwidth of any one of the NPUs 201, 202, . . . 20N. In the specific case of using 10 Gigabit/second capable NPUs as PNPU's to provide the same throughput as a 40 Gigabit/second NPU, “N” would equal 4. As discussed in greater detail below, each of the NPUs operate independently and are physically connected over separate interfaces (busses) to a data link/physical (DLP) processing apparatus. The DLP processing apparatus and the mode of operation of the busses that connect it to the NPUs are the subject of one more of more embodiments of the invention. In one embodiment of the invention, the Data Link Layer processing apparatus includes a sequencer which ensures that packets do not get out of order when being processed by the parallel processing NPUs. In yet another embodiment of the invention, the N busses which interconnect the N NPUs with the Data Link Layer processing apparatus are adapted to operate in either a “quad” mode or a “ganged” mode. In other embodiments of the invention, the framers and data engines within the DLL processing apparatus also have different modes of operation. Most embodiments of the invention involve a novel high-bandwidth-capable CRC (Cyclical Redundancy Checker) technique for use with commercially available CMOS technology. Other embodiments of the invention include increasing data throughput and bus efficiency by data packing and overhead reduction techniques.

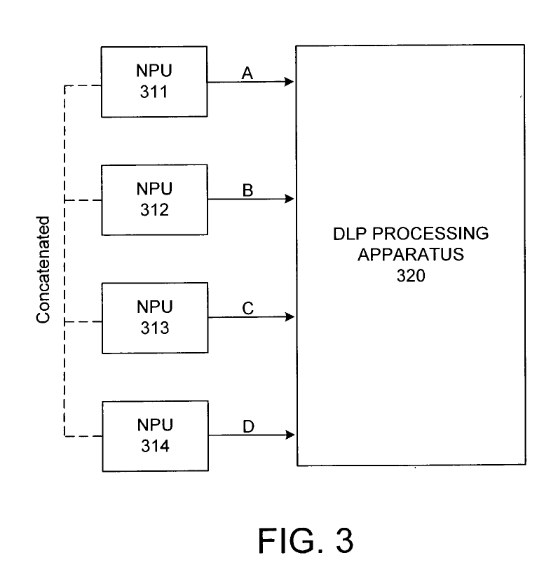

One specific exemplary embodiment of the invention is directed towards a high-speed, low-power Data Link Layer (DLL) processing apparatus for 40 Gb/s (Gigabit per second) or multiport 10 Gb/s Packet Over SONET/SDH (POS) applications. This embodiment in its generic architecture is illustrated in FIG. 3. In this embodiment four standard 10 Gb/s capable NPUs labeled 311, 312, 313 and 314 are coupled to a DLL processing apparatus 320. The DLL processing apparatus 320 operates to provide either a single STS-768/STM-256 SONET/SDH framer or “quad” STS-192c/STM-64 framers. DLP processing apparatus 320 provides full SONET/SDH overhead termination and generation, pointer processing, alarm detection and insertion, as well as error rate monitoring for protection switching. In at least one embodiment of the invention, the DLP processing apparatus 320, due to its low power requirements, may be implemented on CMOS (Complementary Metal Oxide Silicon) devices.

The interfacing of DLP processing apparatus 320 to physical layer components complies with the SPI-5 standard (OIF-2001.145 SerDes framer interface level 5 implementation agreement for 40 Gb/s interface for physical layer devices) and can be configured to connect to one OC-768 optical interface 330 (as shown) or to four OC-192 optical devices via a “nibble” mode. The DLL processing apparatus 320 interfacing to the four standard NPUs incorporates four SPI-4 phase 2 interfaces labeled A, B, C and D.

These interfaces operate in two major modes: “quad” mode (as PNPU's) and “ganged” mode. In quad mode, each SPI-4.2 compliant interface (A, B, C and D) supports independent 10 Gb/s data stream, which can be framed into an STS-192c or a channelized STS-768 SONET frame. In ganged mode, the interfaces A, B, C, and D are combined to create a single 64-bit bus, which can carry data at 40 Gb/s. The ganged mode bus supports channelized STS-768, concatenated STS-768c, or quad STS-192c framing. In this context, “channelized” refers to being able to separate out the available bandwidth into a plurality of channels, each of which may have sources and destinations that are independent of other channels. Channelized STS-768 would be able to support multiple physical nodes for instance that each use their own portion of the same 40 Gb/s total bandwidth. By contrast, “concatenated” STS-768 would support only a single pair of end stations that uses all of the 40 Gb/s at the same time.

Ganged mode is an extension of the SPI-4 phase 2 standard. It is implemented via the four 16-bit interfaces—A, B, C, and D. Interface A carries the most significant bytes, while interface D carries the least significant bytes. Each interface has an active control bit and an associated source clock. In total, there is a 64-bit data bus and four associated control bits for both the transmit and receive directions.

The DLP processing apparatus 320 also supports a “quad” mode (PNPU mode) that enables the four SPI-4.2 interfaces to operate independently as separate buses, and still create a single STS-768c channel. On the transmit side, this mode multiplexes complete packets into an STS-768c frame. In order to ensure packet ordering for data flows is maintained, mechanisms are employed to guarantee this occurs. For the receive side,,sequence numbers are pre-appended to packets as they are extracted from the SONET frame and sent to one of the four SPI-4.2 bus ports. The sequence numbers enable a corresponding entity/device (such as another NPU) on the other side of the receive SPI-4.2 bus to place the packets in arrival order if necessary.

For device control from a CPU, the DLL processing apparatus 320 provides a 16-bit or 32-bit CPU interface. Access to SONET/SDH overhead is provided via internal registers and external serial I/O pins. Applications which DLL processing apparatus 320 can support include terminal equipment such as for SONET/SDH, POS equipment, edge and core routers, multi-service switches, data interfaces, uplink cards, test equipment and Spatial Reuse Protocol (SRP) applications.

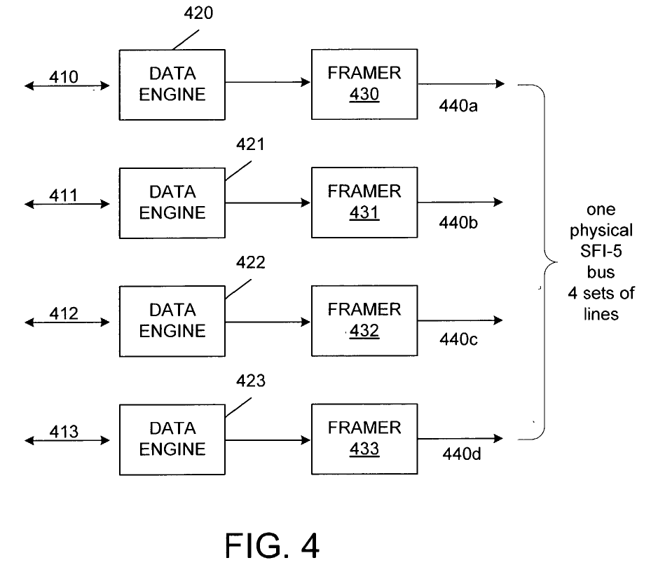

FIG. 4 illustrates at least a first operational embodiment of the invention. In the embodiment illustrated in FIG. 4, the framer, data engine and interfaces (buses) to the data engine are all in “quad mode”. Buses 410, 411, 412 and 413 are all compliant with a protocol that supports the data rate of the NPUs to which they interface. For instance, in the case of 10 Gb/s PNPUs, each bus 410, 411, 412 and 413 is compliant with the SPI 4.2 standard. In this mode, the buses may operate in quad mode wherein each of the buses 410, 411, 412 and 413 are independent and separately carry data without regard to one another. When the buses 410, 411, 412 and 413 are in quad mode, the data engines (which perform data link layer protocol support) 420, 421, 422, and 423, coupled respectively to them, may also be in quad mode. In quad mode, each of the data engines are of a size which supports the data rate from their respective buses. Hence, in the example of SPI 4.2 compliant buses in quad mode, each data engine 420, 421, 422 and 423 would be of an STS-192 size. As shown the framers are also in quad mode, with each framer 430, 431, 432 and 433 interfacing to data engines 420, 421, 422 and 423, respectively. The framers 430, 431, 432 and 433 each provides overhead support for data and prepares it to be driven onto an optical interface (such as SFI-5) for transmission over fiber optic. Assuming that the framers are also in quad mode, and operating with data engines of STS-192 size, the framers 430, 431, 432 and 433 would each prepare data for transmission on one-fourth of the data lines made available by the SPI-5 physical bus. Thus, the data lines on one SPI-5 bus would be divided into four sets, namely, sets 440a, 440b, 440c and 440d, with each set supporting one of the framers 430, 431, 432 and 433. Each framer 430, 431, 432 and 433 therefore prepares data for OC-192 compatible transmission.

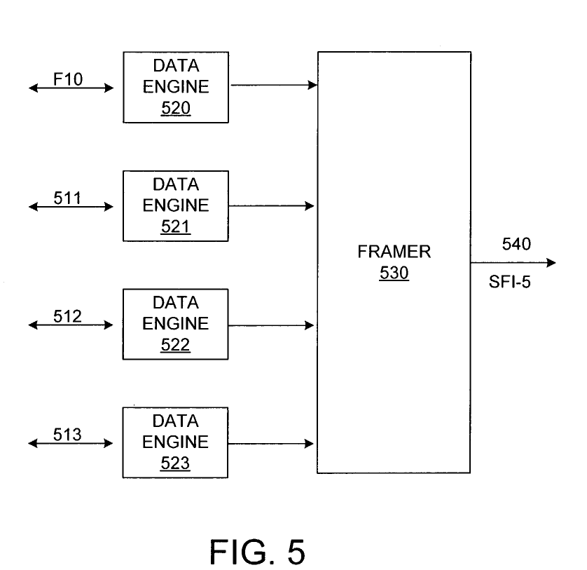

FIG. 5 illustrates at least a second operational embodiment of the DLL processing apparatus. This embodiment has the interfaces to data engine as well as the data engines themselves operating in quad mode servicing a single large framer. Buses 510, 511, 512 and 513 are all compliant with a protocol that supports the data rate of the NPUs/PNPUs to which they interface. For instance, in the case of 10 Gb/s NPUs/PNPUs, each bus 510, 511, 512 and 513 is compliant with the SPI 4.2 standard. In this mode, the buses may operate in quad mode wherein each of the buses 510, 511, 512 and 513 are independent and separately carry data without regard to one another. When the buses 510, 511, 512 and 513 are in quad mode, the data engines (which perform data link layer protocol support) 520, 521, 522, and 523, coupled respectively to them, may also be in quad mode. In quad mode, each of the data engines are of a size which supports the data rate from their respective buses. Hence, in the example of SPI 4.2 compliant buses in quad mode, each data engine 520, 521, 522 and 523 would be of an STS-192 size. As shown the framer 530 is a single large (compared to framers 430 etc. of FIG. 4) framer interfacing to data engines 520, 521, 522 and 523 concurrently. The framer 530 provides overhead support for data and prepares it to be driven onto a single optical interface 540 (such as SFI-5) for transmission over fiber optic. Assuming that the framer is operating with data engines of STS-192 size, the framer 530 would prepare data for transmission on OC-768. The OC-768 framer would be channelized in that the data is presented over multiple channels that result from the data having originated from separate data sources and are intended for separate data destinations.

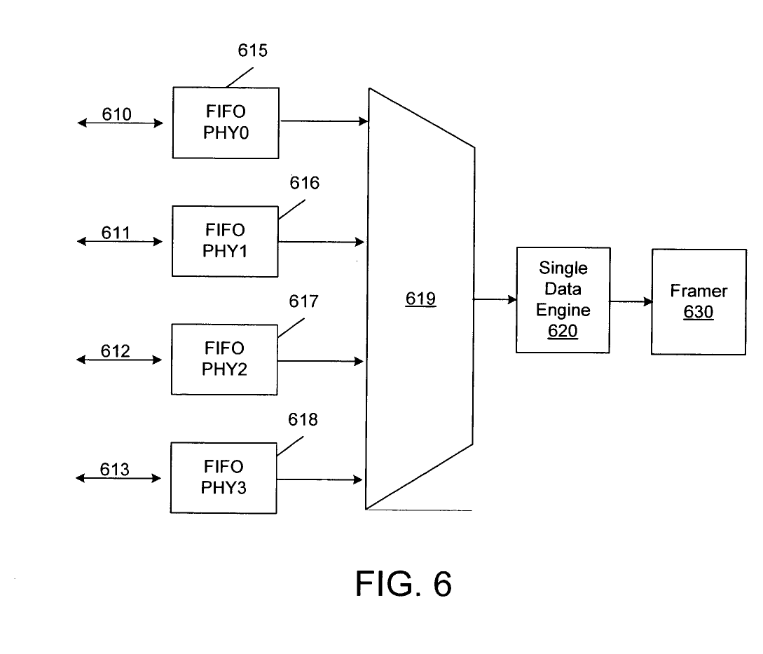

FIG. 6 illustrates at least a third operational embodiment of the DLL processing apparatus. In this mode, buses 610, 611, 612 and 613 are all compliant with a protocol that supports the data rate of the NPUs to which they interface. For instance, in the case of 10 Gb/s NPUs, each bus 610, 611, 612 and 613 is compliant with the SPI 4.2 standard. In this mode, the buses may operate in quad mode wherein each of the buses 610, 611, 612 and 613 are independent and separately carry data without regard to one another. The data engine is not in quad mode but in a “quad MUX” mode. In quad MUX mode, each of the buses 610, 611, 612, 613 separately and independently write data packets to one of four FIFOs 615, 616, 617 and 618, respectively. Each FIFO is associated with a separate PHY port (labeled PHY0, PHY1, PHY2 and PHY 3) for ordering purposes. The state of the FIFOs 615, 616, 617 and 618 is monitored and they are serviced in an as needed fashion to send the data to a single STS-768 capable data engine 620. The data flow control for the FIFOs 615, 616, 617 and 618 is handled by a MUX 619 which outputs data, selectively, to data engine 620.

In one mode, the data source on the originating side of the buses 610, 611, 612 and 613 (i.e. the NPUs), is responsible for sending packets with the same destination address to the same PHY port. This maintains sequence order for related packets. The framer 630 empties the FIFOs with an algorithm that allows packets to not get out of order if they use the same PHY ports. In another mode, the packets are assigned sequence numbers and the MUX 619 selects the FIFO which has the next sequence number among the 4 available sources. The Data Engine 620 empties the data from the 4 channels by obeying the sequence number order.

In Quad MUX mode, the data output from the STS-768 data engine 620 would then be framed into a single STS-768c frame even though it originated from 4 separate sources. This frame is virtually indistinguishable from a frame that is formatted by one 40 Gbps data source.

Other than the embodiments shown and described in FIGS. 4-6, a transparent mode is available for the data engine which passes packets through without any encapsulation by the data engine or framing by bypassing the framer and placing packets directly on an optical interface or other physical layer interface.

Another bus mode supported by the DLP Processing Apparatus is a ganged mode. In ganged mode, the four SPI-4.2 buses operate as one single 64-bit bus. Ganged mode buses can replace the quad mode buses for the embodiments shown and described above with respect to FIG. 4 and FIG. 5 and still provide four (quad) OC-192 and channelized OC-768 framers. In yet another embodiment, ganged SPI-4.2 mode buses do not need a quad MUX data engine in order to provide a concatenated OC-768 framing. Instead, ganged mode buses can support a single large STS-768 data engine.

The table below summarizes the various operational modes of the system, including various embodiments of the invention:

| | Data Engine | |
|---|---|---|
| SPI bus modes | modes | Framer modes |
| Quad | quad STS-192 | quad OC-192 or channelized |
| | | OC-768 |
| Quad | quad MUX | concatenated OC-768 |
| Ganged | quad STS-192 | quad OC-192 or channelized |
| | | OC-768 |
| Ganged | STS-768 | concatenated OC-768 |

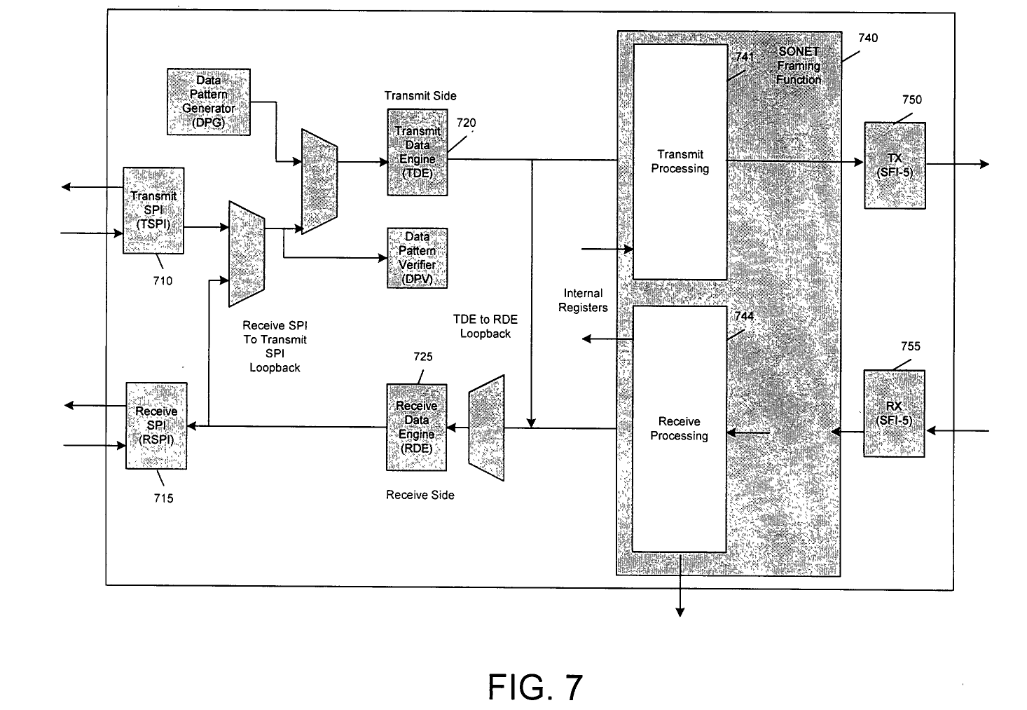

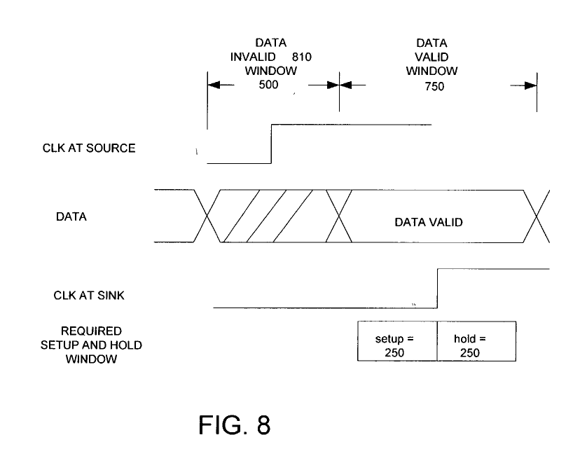

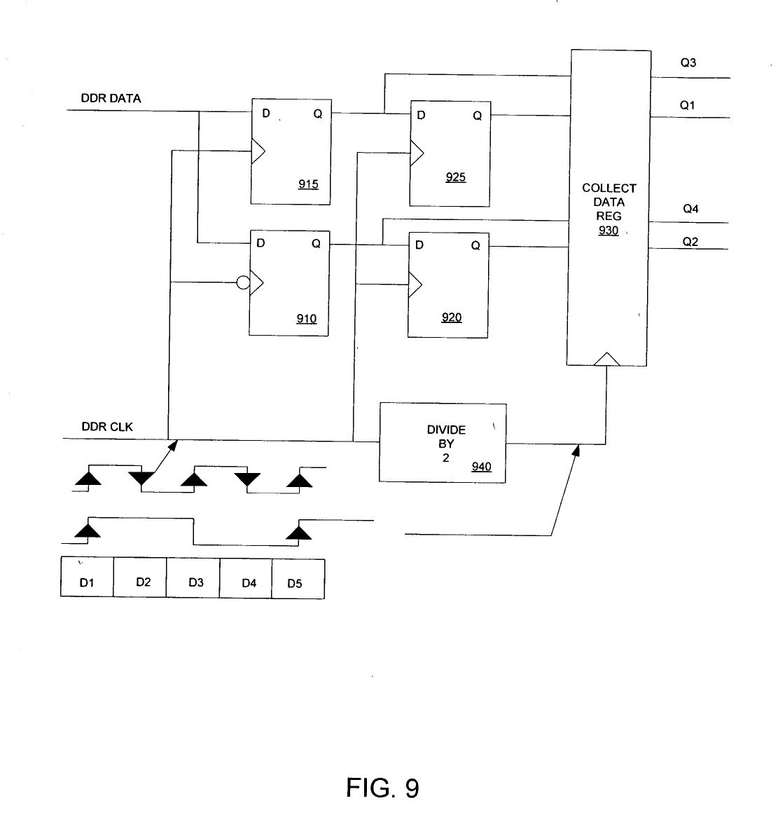

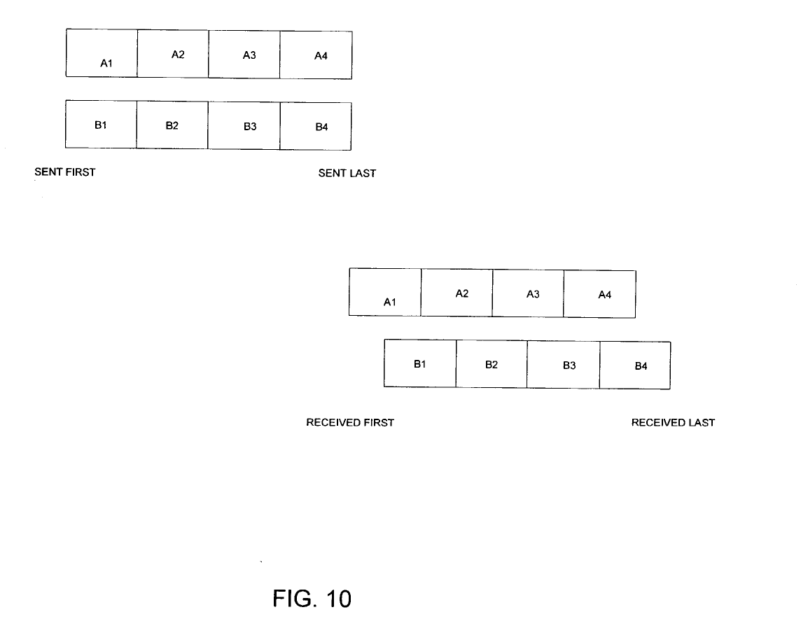

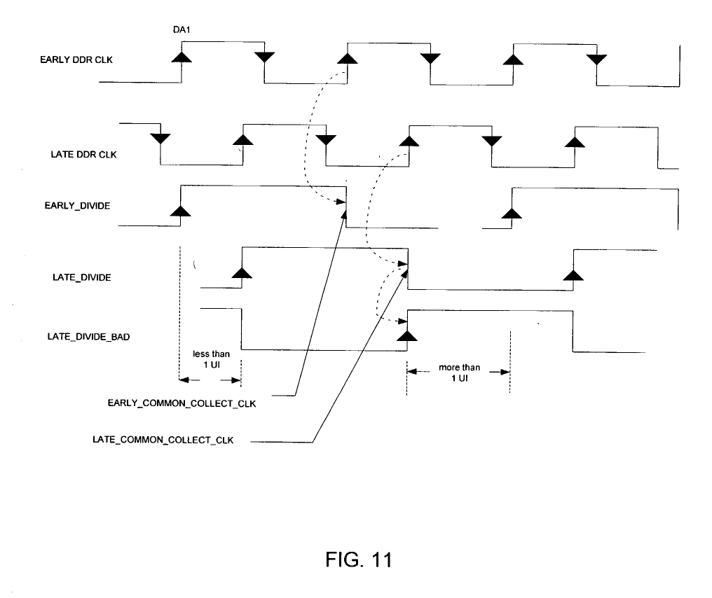

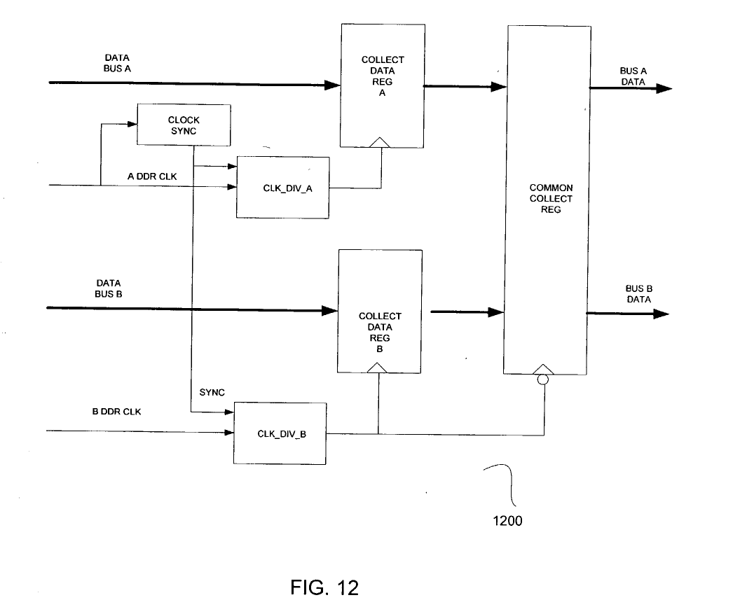

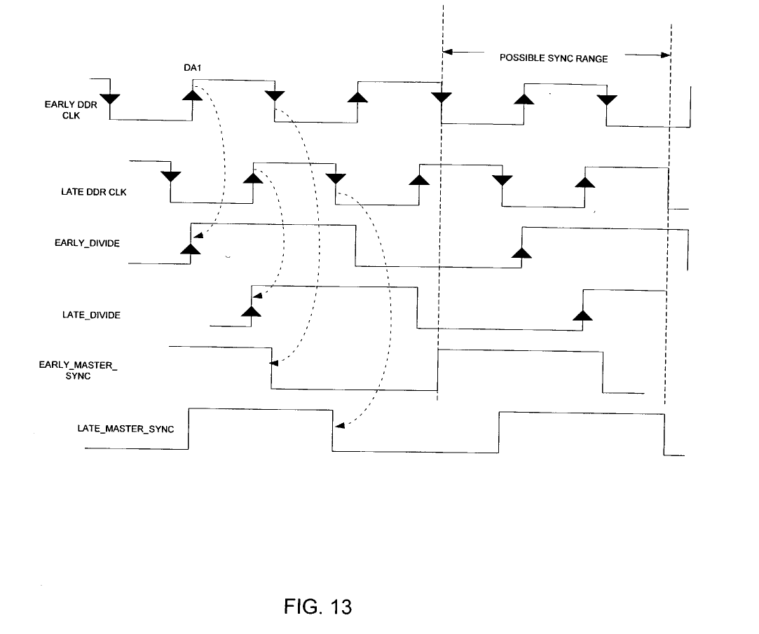

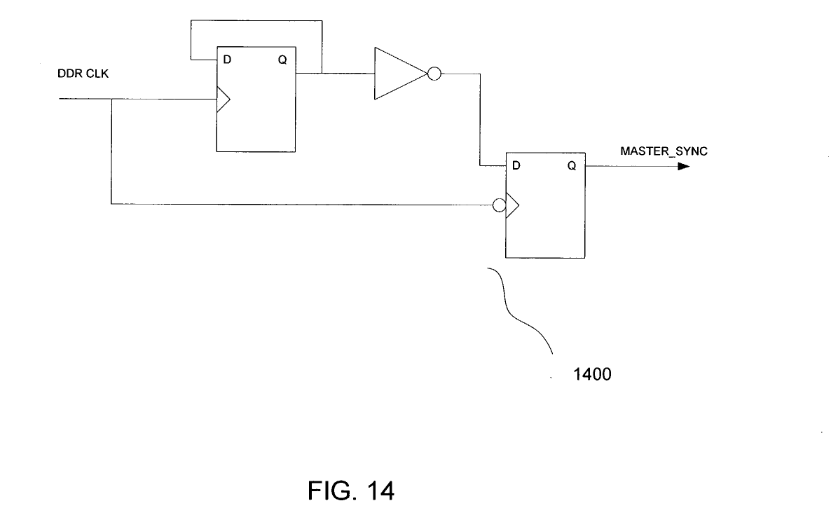

FIG. 7 shows a detailed functional block diagram of a DLP processing apparatus implementable in at least one embodiment of the invention. DLP processing apparatus C20 can be logically divided into a transmit or egress side (for data traversing from the NPUs/PNPUs to the optical interface) and a receive or ingress receive side (for data traversing from the optical interface out to the NPUs/PNPUs).

### Transmit Side

On the transmit side, a Transmit SPI interface D10 connects the DL processing apparatus 320 to 4 SPI-4.2 compliant 16-bit buses. Transmit SPI interface 710 includes, for each bus, the sixteen data pins as well as a transmit control identifier, and a transmit data clock. The data transmitted through the Transmit SPI interface 710 is multiplexed through to a Transmit Data Engine 720 which provide Data Link layer protocol support for Packet Over SONET applications. When the Transmit Data Engine 720 is in transparent mode, it accommodates data traffic that is properly formatted before entering the device. In transparent mode, the Transmit Data Engine 720's task is primarily that of asking for data at the correct rate, and filling all of the payload locations with this data, without regard for its format or content. This mode could, for example, be used for ATM (Asynchronous Transfer Mode) or SDL encapsulations.

Operational modes for the Transmit Data Engine 720 include quad and quad MUX mode. The Transmit Data Engine 720 is most often used in order to provide POS processing. In this regard, the Transmit Data Engine 720 is configure to provide the following:

PPP encapsulation of the packet.

HDLC framing of the PPP encapsulated packets;

CRC-32 generation on the entire packet frame;

Removal of flag characters from the frame by control escape substitution to provide data transparency;

Optional post scrambling with a 1+X⁴³ polynomial.

All but the HDLC framing is scrambled.

The transmit side of a SONET Framing Function 740 include a Transmit Processing 741 and Transmit Optical Interface (not shown). Transmit Processing 741 gathers all external overhead information for all of the framers via a serial interface. Transmit Processing 741 accepts serial words from an external device, converts the words to parallel format, then steers the overhead data to the correct data “lane”. The external device is responsible for transferring the required overhead data into the device before it is needed by the framer. The framer supplies a frame sync output and a status clock output, which is related to the SONET rate clock, that can be used to determine when the required overhead data must be available at the framer. Transmit Processing 741 provides all the transmit-side overhead data that originates inside the framer. The overhead may originate from hardware blocks or from programmable internal registers. The Transmit Optical Interface (not shown) is an interface accepting data processed by Transmit Processing 741 and converts it to a high speed serial interface which is SPI-5 compliant.

### Receive Side

On the receive side, data enters from an optical source over RX interface (SPI-5 compliant) 755. Data enters the receive side through differential lines. If the DLP processing apparatus 740 is in quad mode, then ¼ of the lines is assigned to each apparatus 740. If it is in OC-768 mode, then all inputs are assigned to the single apparatus 740.

Receive Processing 744 separates the transport overhead from the payload envelope. 745 passes the transport overhead to the appropriate overhead termination block. Receive Processing 744 gathers the overhead that needs to be supplied to external devices from all of the four data lanes and writes it to the outside world via a serial interface. The external devices are responsible for further processing, if necessary. The Receive Processing 744 is responsible for termination of overhead bytes inside the framer.

Receive Data Engine 725 may be one or four separate data engines depending on the mode or channelization. Receive Data Engine 725 operates on data that has been extracted from a SONET frame and placed into the receive data FIFO. The POS processing by the Receive Data Engine 725 on the receive side includes the following functions:

Descrambling of the packet

HDLC packet delineation and return of byte-stuffed packets to un-stuffed form

Verification of the CRC-32 FCS

Steering of data engine output to the correct output data FIFO

Optional PPP header removal

Optional PPP filtering

In quad MUX mode, the data engine 725 also prefixes a sequence number to the packet as it is written to the output data FIFO. The sequence number is used by devices on the other side of the SPI-4 RX bus to order packets sent via different SPI-4 buses. The sequence number can be 2 or 4 bytes long. It is pre-appended with the MSB first and the LSB last.

Receive SPI interface 715 accepts data from all of the output FIFOs associated with the data engines and transfers it across the receive SPI busses. Each data engine is assigned a different physical address. The receive SPI interface consists of 4 separate SPI-4 interfaces. These can operate independently or as one large bus. The quad SPI-4 mode is usefull for interfacing with four separate network 10 Gb/s PNPUs. In ganged mode, all 64 bits are used to construct a single data bus that interfaces with a single 40 Gb/s NPU.

The following description analyzes the SPI-4 Phase 2 bus and how it can be used in implementing the various embodiments of the invention. The SPI-4 Phase 2 bus is a Double Data Rate bus operating at a clock rate of 311-400 megahertz. The bus utilizes 17 bits of data and control signals. A source synchronous clock is sent along with the data to assist in data recovery.

This bus is designed to support applications which utilize up to 10 Gb/s. As described above, one way to utilize this bus for higher bandwidth applications would be to operate several of these busses in parallel at the same clock rate. Two ways of doing so include using a separate clock for each bus, or one clock common to all of the busses. Using a single clock would make the data recovery conceptually straightforward. However, this places severe routing constraints on the PCB (Printed Circuit Board) designer. For example, consider the following issues:

### Static Timing Mode of SPI-4 Phase 2 Bus

Consider for instance the static timing mode of the SPI-4 Phase 2 bus. If the data rate was 800 MHz, the clock would be a 400 MHz DDR clock, and each bit time would correspond to 1250 pico-seconds. Since the clock and data are created with the same output circuitry, they exhibit exactly the same timing characteristics. The specified data uncertainty between the clock and the data as it leaves the source drivers is as shown in FIG. 8. A device driver for this application would typically exhibit a skew between drivers on the same part of about a maximum of 250 pico-seconds maximum. This would create a 500 pico-second data uncertainty (invalid) window 810 in relation to the clock output since the data could precede the clock or lag the clock by 250 pico-seconds.

If the receiver requires 250 pico-seconds setup and 250 pico-seconds hold, which are typical values, then the receiver would require at least a 500 pico-seconds data valid window. As long as the actual data valid window is greater than the window required by the receiver, data recovery can be accomplished. For this example, then the clock must be located within the data valid window to within a 250 pico-seconds accuracy. This centering of the clock in the data valid window is typically achieved by adding additional delay into the clock path.

This is a very acceptable solution until the effects of PCB traces are considered. Typical PCB traces experience about 150 pico-seconds delay per inch. Therefore all of the traces of a bus must have matched delays to within 250 pico-seconds accuracy or about 1.66 inches to properly recover the data. Matching an 18 bit bus to this accuracy is difficult enough, matching a 72 bit (four buses with 18 bit lines each) bus to this accuracy is considerably more difficult.

Matching bus lengths is usually done by carefully routing all of the traces as directly as possible. Then if the longest traces can't be reduced in length then the shortest traces have length added to them to make them equal to within a certain amount. Utilizing separate clocks for each bus allow the bus lengths to be matched to different lengths. For example, bus A could be matched to a 4 inch length, bus B to a 6 inch length, bus C to a 8 inch length, and bus D to a 10 inch length. This has very clear advantages for a PCB design since they don't all have to be 10 inches. This is the reason why separate clocks are useful for each bus.

The FIG. 9 circuit is typical of a circuit that can recover a DDR clocked bus and to put it into a clock domain at ½ the incoming clock rate. The lower clock rate makes internal processing easier due to increased cycle times. The presence of the negative edge triggered flip-flop 910 in the first stage allows the receiver to recover the data that is associated with the falling edge of the clock. The first stage flip-flops 910 and 915 are then supplied to a second stage (consisting of flip-flops 920 and 925) which is entirely clocked by a single edge operating at the incoming clock rate. The 4 bits of the first and second stage are then clocked into a single collection register 930 using a single edge of a half rate clock. Thus, one skilled in the art can implement a scheme to recover the data from each individual bus and to convert it to a single edge clock running at ½ the input clock rate. The ½ of the input clock rate is achieved by a divide-by-two block 940.

One additional challenge is how to align the data from multiple busses, so they can be treated as a single entity. FIG. 10 illustrates this point. Even though the data busses are clocked out by the same clock source they arrive at the receiver with an unknown timing relationship between the busses. A3 could either be aligned with B2 or B3 at the receive end. The receiver has no way of knowing which bus is experiencing the greater delay.

The next issues is getting the data from the multiple collect registers into one time domain with the proper alignment between the data busses. The goal is to clock all of the data from the collect data registers for each bus into a single common collect register, utilizing a clock that possesses adequate setup and hold to all of the collect registers.

First, it can be demonstrated that if the total skew between the 4 clocks is constrained to be a portion of a bit time, then such a goal should be achievable. FIG. 11 illustrates the timing for such a scheme. Either of the two divide-by-two clocks can be utilized to clock the common register if we use the falling edge since there is substantial setup and hold for all data.

However, there is one problem. There are two possible relationships between early_divide and late_divide, since they are both unsynchronized divide-by-2 circuits. The late_divide could be going up or down at any positive clock edge as shown in FIG. 11. The late_divide_bad relationship is undesirable. It results in the 2 divide clocks being more than 1 bit time out of phase. Only if the divide clocks are less than 1 bit time out of phase can the data be predictably realigned. Therefore the two divide-by-2 counters must be synchronized to eliminate the unwanted relationship.

This can be achieved by designating any one of the divide-by-2 counters as the master and sending a synchronizing signal to the rest of them to control their phase relationships to the master. This circuit will work as long as the master sync signal arrives at the slave circuit with sufficient setup time to the slave clock. This requires the total of the 3 delays to be less than 1 bit time as shown in FIG. 13. The entire circuit then will look something like the circuit 1200 of FIG. 12.

This synchronizing of the divide-by-two counters is the essence of the circuit. The circuit 1400 of FIG. 14 is used to construct a synchronizing signal from one clock that is sent to all of the divide-by-two counters. Essentially, this signal is itself a divide-by-two signal that is created from the negative edge of the master clock. They will have a high time of one bit time and a low time of one bit time. When this signal is supplied to other divide-by-two counters, it will bracket only one positive clock edge for each counter, and they will all be within 1 bit time of each other. Therefore the unwanted late_divide_bad relationship is prevented from occurring.

The timing of the sync signal and its possible range is illustrated in FIG. 13. The sync signal can occupy the possible sync range area shown depending upon whether the signal is derived from an early or a late clock. As can be seen the signal will still bracket only one positive edge for each incoming clock and therefore this signal can be used to properly synchronize all of the divide-by-two counters.

In order for this circuit to work properly the sum of the maximum skew between any the clocks and the propagation delay time of the synchronizer, and the setup time of the receiving divide-by-two circuit must be less than 1 bit time. If this sum is excessive then the correct phase relationship can't be captured reliably.

### Dynamic Timing Mode of SPI-4 Phase 2 Bus

There is a second timing mode specified for SPI-4 Phase 2 busses. This is referred to as the dynamic timing mode. It does not utilize the source synchronous clock edges to locate the data. Instead it adjusts the skew on each data bit at the receiver individually. It does this by the source sending known patterns and the individual delays are adjusted until the patterns are reliably obtained. This mode and the training patterns sent allow the skew between any 2 signals of a bus to exhibit up to 1 bit time of skew. This timing mode allows more skew between the clock and the data at the expense of circuit complexity.

The synchronizing circuit is also valid for this timing mode. It still requires the clocks to exhibit less than 1 bit time of skew between them. Each data bit can exhibit up to 1 bit time of skew in relation to its clock as per the SPI specification. In this case the circuit allows for up to 1+1+0.8 bits of skew across the entire wide of the data busses. This allows the PCB designer even more flexibility in the length of the required PCB traces. The 4 clock traces again must be matched only to within about ¾ of a bit time or about 6 inches. This would allow up to 24 inches of trace mismatch between data bits.

### CRC Processing

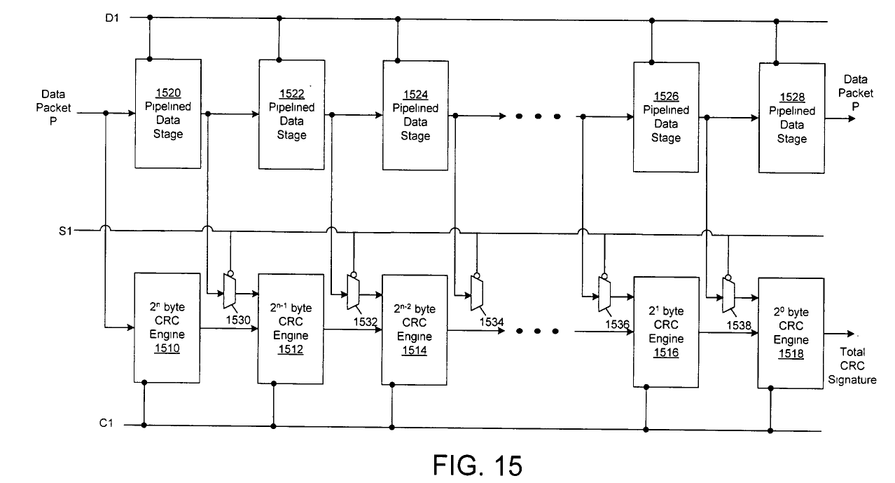

In multi-byte wide data paths that are designed to transport data packets that can be any arbitrary number bytes in size, such as those mentioned above in various embodiments above, it may be desirable to have a CRC calculated or verified. The CRC calculation which is implemented to support data paths should be able to start at any arbitrary byte, and end at any arbitrary byte. The CRC architecture which is the subject of one embodiment of the invention is advantageous over conventional CRC in that it uses a pipelined design with separate CRC engines. Each of these CRC engines is capable of handling a data width that is 2 times the data width of the previous CRC engine in the pipeline. Intermediate packet sizes (i.e. those that are not a power of 2) are handled by enabling those CRC engines that will correspond to the packet data width. Thus, packets of all sizes can be handled with a minimum number of CRC engines. The pipelining of the CRC engines makes it possible to handle wide data paths, and implement the logic in technologies with diverse logic delays and at various clock frequencies. Longer gate delays, and faster clock frequency designs can be handled by increasing the pipeline stages. By pipelining, part of larger CRC calculation is done in one clock cycle. The CRC computation logic can be split into multiple stages if higher clock speeds are to supported. Lower clock speeds can be supported by using as many clock cycles as you needed to achieve the lower rate. FIG. 15 illustrates one embodiment featuring a pipelined CRC architecture.

Our design realigns the packet over the data path such that a new packet always starts at the start of a new word in the data path. So only the end of a packet is at any arbitrary byte location—the start of the packet is always at a well defined byte position. The realignment of data is done in a previous data path stage before the data enters the CRC logic.

Packets that are larger than the data path are divided over as many cycles as needed to fit the packet. Each cycle processes data of data path width. Since the data was aligned to the data path in the previous stage, only the last cycle may have a partial packet—all other cycles will be completely filled.

The first stage is the one that handles the widest CRC calculation—the one that is as large as the data path. Successive stages divide the data path by 2, and have CRC blocks that are half the size of the previous stage. Since the first stage is the widest, if a packet is stored across multiple cycles, the result of the calculation from the first stage is immediately available for the next cycle

Assume that the CRC architecture illustrated is designed to accept a maximum packet size of K. Then, the architecture would include a series of n+1 pipelined data stages, of which 1520, 1522, 1524, 1526 and 1528 are pictured explicitly, as well as a series of n+1 CRC engines 1510, of which 1512, 1514, 1516 and 1518 are pictured explicitly, where n+1=log₂ (K+1). Each data stage consists of storage elements such as buffers and flip-flops, and is controlled by control information/signal(s) D1. Each CRC engine computes CRC in a manner that may be unique or well-known in the art, depending upon the implementation. Each of the CRC engines are also controlled by a control information/signal(s) C1. A given CRC engine and the preceding CRC engine (except for CRC engine 1510) are interposed by a data selection unit. FIG. 15 shows that there are n such data selection units with those pictured explicitly being data selection unit 1530, 1532, 1534, 1536 and 1538. Each data selection unit is controlled by control information/signal(s) S1. Each data selection unit takes as input data from the data stage to which it is connected and outputs to its corresponding CRC engine, only that data which it needs. The output signature from each CRC engine is passed through to the next succeeding CRC engine.

Assume a data packet P upon which a CRC needs to be computed has a size M. The first data stage 1520 receives the entire packet (all M bytes). Several cases are possible:

### M is Exactly 2ⁿ

In this case, the packet P is fed to CRC engine 1510 which computes an output signature O based on all bytes of the packet. Since the entire packet was processed at CRC engine 1510, each successive CRC engine (1512, 1514, etc.) does not need to be enabled. The output signature O propagates from CRC engine 1510 to CRC engine 1520 and so on, until it is output at CRC engine 1518. The data packet P must also be propagated through the pipelined data stages 1520, 1522 and so on until it is output as data stage 1528. Since no bytes of the packet need to be input to CRC engines succeeding CRC engine 1510, the data selection units 1530, 1532, and so on will not select any of the bytes of packet P to pass along to the CRC engines they service.

### M is Greater than 2ⁿ but less than K

In this case, the packet P is fed to CRC engine 1510 which computes an intermediate output signature O(n) based on the first 2ⁿ bytes of the packet P. The intermediate output signature O(n) propagates from CRC engine 1510 to CRC engine 1512 and so on, until it is output at CRC engine 1518. The data packet P must also be propagated through the pipelined data stages 1520, 1522 and so on until it is output as data stage 1528. Since only 2ⁿ bytes of the packet have been used for,generating an output signature, the remaining M−2ⁿ bytes need to be processed.

Next, we would consider whether M−2ⁿ div 2ⁿ⁻¹ equals one. If not, then no data would need to be fed to the 2ⁿ⁻¹ CRC engine 1512, and thus, selection unit 1530 would not choose any bytes from packet P as propagated at the output of data stage 1520. If so, the next 2ⁿ bytes of the output of data stage 1520 are selected by data selection unit 1530 and then passed to the CRC engine 1512. CRC engine 1512 then computes an intermediate CRC output signature O(n−1) and passes this along to CRC engine 1514. In either case the intermediate output signature O(n) from CRC engine 1510 would need to be propagated through to CRC engine 1512 and out to CRC engine 1514.

In a like manner, each of the CRC engines either 1) takes as input data from the data selection unit to which it is coupled and computes the CRC thereon or 2) takes no data and is bypassed such that it merely passes on any intermediate output signature(s) from previous CRC engines. The total CRC signature which is a concatenated (or otherwise combinational) function of all the intermediate output signatures such as O(n), O(n−1) etc. which were generated by the various CRC engines. Note that certain intermediate output signatures may not have been generated. The total CRC signature is output from the final CRC engine, namely CRC engine 1518, in the pipeline. All M bytes of the original data packet P will be propagated through each of the pipelined data stages 1520, 1522 . . . 1528 and be output intact from data stage 1528.

One way of controlling which of the CRC engines and data selection units are enabled is by the use of the aforementioned control information/signals C1, S1 and D1. If the number of bytes valid in each data transfer can be discovered then the CRC engines to be enabled can be determined simply by applying the binary representation of this number to form the control information/signals C1 and S1.

For instance, if n=7, then the CRC architecture pictured would capable of accepting packets up to a size K=255 bytes. If M, the size of packet P, is 131, then, CRC engine 1510 (which processes the most/least significant 128 bytes of M), CRC engine 1516 (which processes the next 2 most/least significant bytes) and CRC engine 1518 (which processes the last/first most/least significant byte) would all be enabled, while all other CRC engines, 1512, 1514 etc. would be disabled. Also, data selection units 1536 and 1538 would be enabled to select 2 and 1 bytes, respectively, from the data packet P traversing through the pipelined data stages. The total CRC signature would be composed of the intermediate output signatures O(7), O(1) and O(0). The control signal/information C1 and D1 could be simply generated by reference to the binary representation of 131 or 10000011. This representation when considered along with the order of the CRC engines to be enabled, shows a direct correspondence and can thus be used as an enabling/disabling mechanism.

Although the present invention has been described in detail with reference to the disclosed embodiments thereof, those skilled in the art will appreciate that various substitutions and modifications can be made to the examples described herein while remaining within the spirit and scope of the invention as defined in the appended claims. Also, the methodologies described may be implemented using any combination of software, specialized hardware, firmware or a combination thereof and built using ASICs, dedicated processors or other such electronic devices.

What is claimed is:

1. A method for implementing a network to network interconnection using N network processors which operate in a parallel fashion, each processor capable of handling data up to a bandwidth of M, said method comprising:
configuring N lower speed interfaces to operate in one of a plurality of modes, each of said N lower speed interfaces carrying data at a rate of M, said interfaces coupling said network processors to a single data engine, said data engine capable of handling data at a bandwidth of N multiplied by M.

2. A method according to claim 1 wherein a second of said modes is a quad mode wherein said N interfaces operate independent of one another.

3. A method according to claim 1 wherein a second of said modes is a ganged mode wherein said N interfaces operate together such that they simulate the behavior of a single higher speed interface capable of carrying data at a bandwidth of N multiplied by M.

4. A method according to 2 further comprising:
appending a sequence number to packets carrying said data; and
utilizing said sequence number information to ensure that said packets are provided to said data engine in the order in which they egressed from said network processors.

5. A method according to claim 4 further comprising:
multiplexing of said packets over all N said lower speed interfaces, said multiplexing selecting a packet from one of said lower speed interfaces having the lowest sequence number.

6. A method according to claim 3 including:
synchronizing the signals carried over said interfaces such that when data is recovered from them, it is aligned correctly.

7. A method according to claim 1 further comprising:
generating a Cyclical Redundancy Checking signature for each of said packets egressing from said single data engine, each of said packets having an arbitrary size, said generation in a pipelined fashion.

8. A method according to claim 7 wherein generating value includes:
passing said packet through each of a plurality of successive pipelined data stages, each said stage capable of outputting a specified portion of said packet as input to a corresponding one of a plurality of successive pipelined CRC engines, each CRC engine handling data of a size larger than the CRC engine succeeding it;
if the size of said corresponding CRC engine is such that it can exactly handle said specified portion, then inputting said specified portion thereto and generating an intermediate CRC value therefrom; and
if the size of said corresponding CRC engine is such that it cannot exactly handle said specified portion, then bypassing said corresponding CRC engine.

9. A method according to claim 8 wherein said specified portion begins with the entire said packet and is reduced at each of said pipelined data stages if said corresponding CRC engine was not bypassed.

10. A method according to claim 8 wherein said CRC signature value is composed of the entire set of generated intermediate CRC values.

11. A method according to claim 8 wherein each said CRC engine is capable of handling data that is of a size twice the succeeding CRC engine.

12. A method according to claim 6 wherein synchronizing the interfaces includes:
utilizing a separate clock for each of said interfaces; and
synchronizing said clocks by sending a synchronization signal from one of said clocks to all other said clocks.

13. A method according to claim 12 wherein utilizing said clocks includes:
dividing the signal of each clock by two, each said resulting divide by two clocking signal clocking a collect data register for the interface of each said clock.

14. A method according to claim 13 wherein synchronizing said clocks includes:
designating as master the divide by two clocking signal of the clock from which the synchronization signal is sent;
generating a divide by two synchronizing signal from said master; and
sending said divide by two synchronization signal to each of the other clocks which are not designated as master in order to align the phases thereof to the master.

15. A system for interconnecting networks, said comprising:
N network processors, each capable of processing data packets ingressing at a maximum bandwidth of M;
N low speed interfaces, each said low speed interface capable of carrying said processed data packets at a maximum bandwidth of M, said N interfaces operating in one of a plurality of modes; and
a single data engine, said single data engine capable of further processing said processed data packets at a rate of N multiplied by M.

16. A system according to claim 15 wherein a second of said modes is a quad mode wherein said N interfaces operate independent of one another.

17. A system according to claim 15 wherein a second of said modes is a ganged mode wherein said N interfaces operate together such that they simulate the behavior of a single higher speed interface capable of carrying data at a bandwidth of N multiplied by M.

18. A system according to 16 further comprising:
a sequence number generator appending said generated sequence numbers to packets carrying said data; and
a packet re-ordering means utilizing said sequence number information to ensure that said packets are provided to said data engine in the order in which they egressed from said network processors.

19. A system according, to claim 18 further comprising:
a packet multiplexing means for said packets over all N said lower speed interfaces, said multiplexing selecting a packet from one of said lower speed interfaces having the lowest sequence number.

20. A system according to claim 17 including:
synchronizing means for synchronizing the signals carried over said interfaces such that when data is recovered from them, it is aligned correctly.

21. A system according to claim 15 further comprising:
a Cyclical Redundancy Check (CRC) signature generator generating a CRC signature for each of said packets egressing from said single data engine, each of said packets having an arbitrary size, said generator configured in a pipelined fashion.

22. A system according to claim 21 wherein said CRC signature generator includes:
a plurality of successive pipelined CRC engines, each CRC engine handling data of a size larger than the CRC engine succeeding it, each said CRC engine capable of generating an intermediate CRC value; and
a plurality of successive pipelined data stages each configured to pass said packet to the succeeding data stage, each said data stage capable of outputting a specified portion of said packet as input to a corresponding one of said CRC engines, further wherein,
if the size of said corresponding CRC engine is such that it can exactly handle said specified portion, then inputting said specified portion thereto and generating said intermediate CRC value therefrom, else if the size of said corresponding CRC engine is such that it cannot exactly handle said specified portion, then bypassing said corresponding CRC engine.

23. A system according to claim 22 wherein said specified portion begins with the entire said packet and is reduced at each of said pipelined data stages if said corresponding CRC engine was not bypassed.

24. A system according to claim 22 wherein said CRC signature value is composed of the entire set of generated intermediate CRC values.

25. A system according to claim 22 wherein each said CRC engine is capable of handling data that is of a size twice the succeeding CRC engine.

26. A system according to claim 20 wherein said synchronizing means includes:
means for utilizing a separate clock for each of said interfaces; and
a synchronization signal generation means sending a synchronization signal from one of said clocks to all other said clocks.

27. A system according to claim 26 wherein utilizing said clocks includes:
dividing means for dividing the signal of each clock by two, each said resulting divide by two clocking signal clocking a collect data register for the interface of each said clock.

28. A system according to claim 27 wherein synchronizing said clocks includes:
means for designating as master the divide by two clocking signal of the clock from which the synchronization signal is sent;
generating means for generating a divide by two synchronizing signal from said master; and
means for sending said divide by two synchronization signal to each of the other clocks which are not designated as master in order to align the phases thereof to the master.

29. A system for computing the Cyclic Redundancy Check (CRC) signature for a data packet, said data packet having an arbitrary size, said system comprising:
a plurality of pipelined data stages, each said data stage passing forward the entire said data packet to the succeeding pipelined data stage, each said data stage capable of outputting only a specified portion of said data packet; and
a plurality of pipelined CRC engines, each CRC engine capable of handling data of a size larger than the succeeding CRC engine, each CRC engine capable of generating an intermediate CRC value based upon the specified portion of said data packet passed thereto, further wherein if the size of said corresponding CRC engine is such that it can exactly handle said specified portion, then inputting said specified portion thereto and generating said intermediate CRC value therefrom, else if the size of said corresponding CRC engine is such that it cannot exactly handle said specified portion, then bypassing said corresponding CRC engine.

30. A system according to claim 29 wherein said specified portion begins with the entire said packet and is reduced at each of said pipelined data stages if said corresponding CRC engine was not bypassed.

31. A system according to claim 29 wherein said system includes:
a selection mechanism configured to pass said specified portion of said data packet from said data stage to said corresponding data engine if the size of said corresponding CRC engine is such that it can exactly handle said specified portion.

32. A system according to claim 29 wherein said CRC signature value is composed of the entire set of generated intermediate CRC values.

33. A system according to claim 29 wherein each said CRC engine is capable of handling data that is of a size twice the succeeding CRC engine.

34. A method according to claim 1 which enables Parallel Network Processing (PNP) that allows multiple processors capable of handling lower bandwidths to work together to process higher bandwidths.
